(19) United States
(12) Patent Application Publication
(10) Pub. No.: US 2025/0198599 A1
(43) Pub. Date: Jun. 19, 2025

(54) Lamp Body Assembly and Lamp

(71) Applicant: NVC INNOVATIONS PTE. LTD., Singapore (SG)

(72) Inventors: Donglei WANG, Zhuhai (CN); Bingbing ZHOU, Zhuhai (CN); Xu CHEN, Zhuhai (CN); Songhong DING, Zhuhai (CN); Xiongwen YIN, Zhuhai (CN)

(21) Appl. No.: 18/981,122

(22) Filed: Dec. 13, 2024

(30) Foreign Application Priority Data
Dec. 13, 2023 (CN) 202323414107.4

(51) Int. Cl. F21V 13/10; F21V 3/02; F21V 21/04

(52) U.S. Cl. CPC F21V 13/10; F21V 3/02; F21V 21/047

(57) ABSTRACT

The present disclosure provides a lamp body assembly and a lamp. The lamp body assembly includes an outer peripheral structure, an inner peripheral structure and a light transmission member, where an outer edge space is formed between the inner peripheral structure and the outer peripheral structure, a middle space is formed by an inner periphery of the inner peripheral structure, a light emergent side of the lamp body assembly includes an outer edge light emergent area, and the light transmission member is arranged between the outer edge space and the outer edge light emergent area; on an orthographic projection of the light emergent side, a ratio of a width of the outer edge light emergent area to a distance from the outer edge light emergent area to a center of the light emergent side ranges from 1:100 to 3:10.

### CROSS-REFERENCE TO RELATED APPLICATION(S)

The present invention claims priority to and the benefit of Chinese Patent Application No. 202323414107.4, filed with the China National Intellectual Property Administration on Dec. 13, 2023, which is hereby incorporated by reference in its entirety.

### FIELD

The present disclosure relates to lamps, in particular to a lamp with two or more light sources and a lamp body assembly thereof for improving an illumination effect.

### BACKGROUND

One type of existing downlights features a main light source and a decorative light source. The main light source achieves main illumination in a central area on a light emergent side of the downlight. The decorative light source achieves decorative illumination effects of a night light or an ambient light at an outer edge of the light emergent side of the downlight. The light emergent side refers to the lower side of the downlight. Specifically, the downlight includes a lamp body and a light reflecting cup. An interior of the downlight is formed between a top wall and an outer peripheral wall of the lamp body assembly, and the light reflecting cup is fixed in the interior. In this way, a middle space is defined on an inner periphery of the light reflecting cup. A surrounding outer edge space is formed between the light reflecting cup and the out peripheral wall. Circuit boards of the main light source and the decorative light source are arranged in the interior and fixedly arranged on a lower side of the top wall. The main light source exactly faces the middle space, and the decorative light source exactly faces the outer edge space. Certainly, the downlight also includes a lampshade positioned on the light emergent side. The common or respective opposite lampshades are installed to lower openings of the middle space and the outer edge space. Thus the interior of the downlight is divided into areas, and the two light sources emit light from different areas.

However, a proportion of the two illumination areas on the light emergent side of this type of downlights is uncoordinated. More specifically, an outer edge decorative illumination area tends to take up a larger proportion, and the decorative light irradiation area or intensity is beyond the demand of a user, thus affecting comfort.

### SUMMARY

Some embodiments of the present disclosure are to provide a lamp body assembly for improving an illumination effect.

Some embodiments of the present disclosure are to provide a lamp for improving the illumination effect.

In an embodiment of the present disclosure, a lamp body assembly includes an outer peripheral structure, an inner peripheral structure and a light transmission member, where the inner peripheral structure is arranged on an inner periphery of the outer peripheral structure, an outer edge space is formed between the inner peripheral structure and the outer peripheral structure, a middle space is formed by an inner periphery of the inner peripheral structure, a light emergent side of the lamp body assembly includes an outer edge light emergent area opposite to the outer edge space, and the light transmission member is arranged between the outer edge space and the outer edge light emergent area; on an orthographic projection of the light emergent side, a ratio of a width of the outer edge light emergent area to a distance from the outer edge light emergent area to a center of the light emergent side ranges from 1:100 to 3:10; the width of the outer edge light emergent area is a first size or a second size; the first size is a distance between the outer peripheral structure and the inner peripheral structure at an outlet of the outer edge space on the orthographic projection of the light emergent side; and the second size is a width of an exposed front light emergent surface of the light transmission member on the orthographic projection of the light emergent side.

It can be seen from the above solution that in the present disclosure, a narrow-ring or narrow-slit light emergent effect of a decorative illumination area is mainly achieved. A width of the decorative illumination area, that is, the outer edge light emergent area needs to be controlled to be below a certain proportion mainly. Decisive factors for formation of the outer edge light emergent area are not the same under different structures of lamps. In an embodiment, as for the downlight described in the background art, a light source of the downlight is emitted through a lampshade, and in practice, a factor determining the width of the outer edge light emergent area is a distance between the light reflecting cup and the outer peripheral wall. Certainly, the lampshade is also the light transmission member in the present disclosure. For some lamps, the outer edge space is practically shielded instead of facing the light emergent side, and light is transmitted to the light emergent side through the exposed light transmission member. The width of the outer edge light emergent area of these lamps is mainly determined by a width of the exposed and downward light emergent surface of the light transmission member. Thus the present disclosure restricts different features in size proportion through two different designs for the lamps. Both means may limit the width of the outer edge light emergent area, and finally a narrow-ring or narrow- slit light emergent effect is presented. A softer and more comfortable illumination effect is produced, and the use experience is improved.

In an embodiment, the light transmission member includes a lampshade, and the lampshade is arranged at an outlet of the middle space and the outlet of the outer edge space; and the width of the outer edge light emergent area is the first size.

It can be seen from the above that in the downlight described in the background technology, the light reflecting cup is the inner peripheral structure of the present disclosure. The light source of the downlight is emitted through the lampshade, and in practice, a factor determining the width of the outer edge light emergent area is a distance between the light reflecting cup and the outer peripheral wall. In this case, the distance between the light reflecting cup and the outer peripheral wall should be adjusted.

In an embodiment, the lamp body assembly includes a lamp body, where the lamp body includes an outer peripheral wall; the lamp body assembly further includes an anti-glare ring, where the anti-glare ring is connected to an inner side of the outer peripheral wall; the outer peripheral structure includes the outer peripheral wall and the anti-glare ring, and the outer edge space is located between the inner peripheral structure and the outer peripheral wall; and the first size is a distance between the outer peripheral wall and the inner peripheral structure or a distance between the anti-glare ring and the inner peripheral structure at the outlet of the outer edge space on the orthographic projection of the light emergent side.

It can be seen from above that the downlight is provided with strong light gathering ability, especially illumination on objects produces a strong atmospheric effect, and addition of anti-glare may effectively prevent glare caused by light, the light is softened, and comfort is improved. The anti-glare ring is a light shielding member. In this way, the width of the outer edge light emergent area is practically determined by a distance between the anti-glare ring and the inner peripheral structure.

In an embodiment, a gap is formed between the inner peripheral structure and the lampshade in a forward direction on the light emergent side.

It can be seen from above that the arrangement of the gap allows light of the first light source to penetrate from the gap and to be closer to a middle light emergent area. In this way, when the outer edge light emergent area and the middle light emergent area emit light simultaneously, main light and decorative light overlap with each other at a boundary between the main light and the decorative light, a rigid light boundary is weakened, and a softer and more comfortable halo effect is produced.

In an embodiment, the lamp body assembly further includes a light shielding member arranged on the light emergent side, where the light shielding member shields the outer edge space from a forward direction of the light emergent side; the light transmission member extends from a position between the light shielding member and the outer peripheral structure to an outer periphery of the light shielding member, and at least a part of the front light emergent surface is exposed to the light emergent side from the outer periphery of the light shielding member; and the width of the outer edge light emergent area is the second size.

It can be seen from above that the outer edge space of such a lamp is practically shielded from the front by the light shielding member such as the anti-glare ring mentioned above, and the light source cannot directly emit light downwards. In an embodiment, the light is incident on the light transmission member, and then the exposed light transmission member transmits the light to the light emergent side and emits the light. Then, the width of the outer edge light emergent area of these lamps is obviously determined by the width of the exposed and downward light emergent surface of the light transmission member. In this case, the width of the exposed and downward light emergent surface of the light transmission member should be adjusted.

In an embodiment, the light transmission member includes a cup portion and a ring portion, the cup portion sleeves the inner peripheral structure, and the ring portion is arranged on the light emergent side; and a light transmission gap is formed between the inner peripheral structure and the light shielding member, and the cup portion is arranged towards the light transmission gap.

It can be seen from above that with this arrangement, the first light source in the outer edge space may emit light from an inner peripheral position of the light shielding member through the light transmission gap, such that the first light source may reach different positions through at least two different light paths to emit light, and different light emergent effects are presented compared with the prior art.

In an embodiment, the lamp body assembly includes a lampshade, where the lampshade is arranged on the light emergent side and shields the middle space; and the cup portion is opposite the lampshade through the light transmission gap.

It can be seen from above that under this arrangement, in the middle of the light emergent side, a center of the lampshade is set as main illumination light, an edge of the lampshade is set as a night light or an ambient light. Then a circle of night light or atmosphere light is arranged at an outer edge of the light emergent side separated by the light shielding member such as the anti-glare ring.

In an embodiment, the lampshade is connected to the light transmission member, and the light shielding member is connected to the lampshade.

In an embodiment, in an orientation of the light emergent side, a light emergent surface of the lampshade and the front light emergent surface are located at different positions.

In an embodiment, in the orientation of the light emergent side, the front light emergent surface is farther away from a first light source and/or a second light source than the light emergent surface of the lampshade.

It can be seen from above that the plurality of light emergent areas are located at least at two different horizontal heights, so as to produce a light effect with a more layered feeling.

In an embodiment, the inner peripheral structure includes a light reflecting cup, and the outlet of the outer edge space is formed between an edge of the light reflecting cup and the outer peripheral structure; and the light transmission member includes a light transmission ring, and the light transmission ring is arranged at the outlet of the outer edge space.

It can be seen from above that some lamps need to be provided with higher light reflecting cups. On this premise, the light transmission member is arranged in a ring shape and is arranged between a bottom edge of the light reflecting cup and the outer peripheral wall, such that light transmission and multi-directional light emergence may be implemented without influencing an original internal structure of the lamp body.

In an embodiment, the light shielding member includes an anti-glare ring.

It can be seen from above that with this arrangement, parts such as the lampshade and the anti-glare ring are disassembled more easily.

In an embodiment, the light transmission member includes a side light emergent surface, and the side light emergent surface is located on an outer periphery of the lamp body assembly; and/or, a part of the light transmission member is located at an outer peripheral edge of the lamp body assembly, and the part of the light transmission member includes a back light emergent surface having an orientation opposite to that of the front light emergent surface.

It can be seen from above that under such an arrangement, the night light or ambient light may be set to achieve side light emergence and/or back light emergence. Combined with the above light transmission gap, in practice, the night light or the ambient light may finally be emitted from different directions and different positions, so as to present a more special illumination effect.

In an embodiment, on the orthographic projection of the light emergent side, the outer edge light emergent area is annular, arc-shaped or discontinuous annular.

It can be seen from above that under this arrangement, continuous or discontinuous annular or arc-shaped narrow-ring or narrow-slit light emergent effect may be achieved.

In an embodiment, the lamp body assembly includes a lamp body and a circuit board, where the lamp body includes a top wall and an outer peripheral wall, and the outer peripheral wall includes the outer peripheral structure; and the circuit board is fixed on a lower side of the top wall, the first light source and the second light source are fixedly connected to the circuit board, and the first light source and the second light source are coplanar.

It can be seen from above that the two light sources may share a same PCT plate for coplanar design, parts are reduced, structural design is simplified, and lower design cost is facilitated. Moreover, the first light source as a night light or a decorative light is farther away from the light emergent side, and a more uniform and softer light effect may be exhibited.

In an embodiment, the inner peripheral structure is a light reflecting cup, a lamp cup, a light shielding cover or an annular component.

In an embodiment of the present disclosure, a lamp is provided. The lamp includes a lamp body assembly, a first light source and a second light source, where the above lamp body assembly is used as the lamp body assembly, the first light source is arranged in the outer edge space, and the second light source is arranged in the middle space.

### BRIEF DESCRIPTION OF DRAWINGS

FIG. 1 is a sectional view of lamp embodiment 1 of the present disclosure;

FIG. 2 is an enlarged view of portion A in FIG. 1;

FIG. 3 is a sectional view of lamp embodiment 2 of the present disclosure;

FIG. 4 is an enlarged view of portion B in FIG. 3;

FIG. 5 is a sectional view of lamp embodiment 3 of the present disclosure;

FIG. 6 is an enlarged view of portion C in FIG. 5;

FIG. 7 is an exploded structural view of lamp embodiment 3 of the present disclosure;

FIG. 8 is a sectional view of lamp embodiment 4 of the present disclosure;

FIG. 9 is an enlarged view of portion D in FIG. 8;

FIG. 10 is a sectional view of lamp embodiment 5 of the present disclosure;

FIG. 11 is an enlarged view of portion E in FIG. 10; and

FIG. 12 is a partial sectional view of lamp embodiment 6 of the present disclosure.

### DESCRIPTION OF EMBODIMENTS

### Lamp Embodiment 1

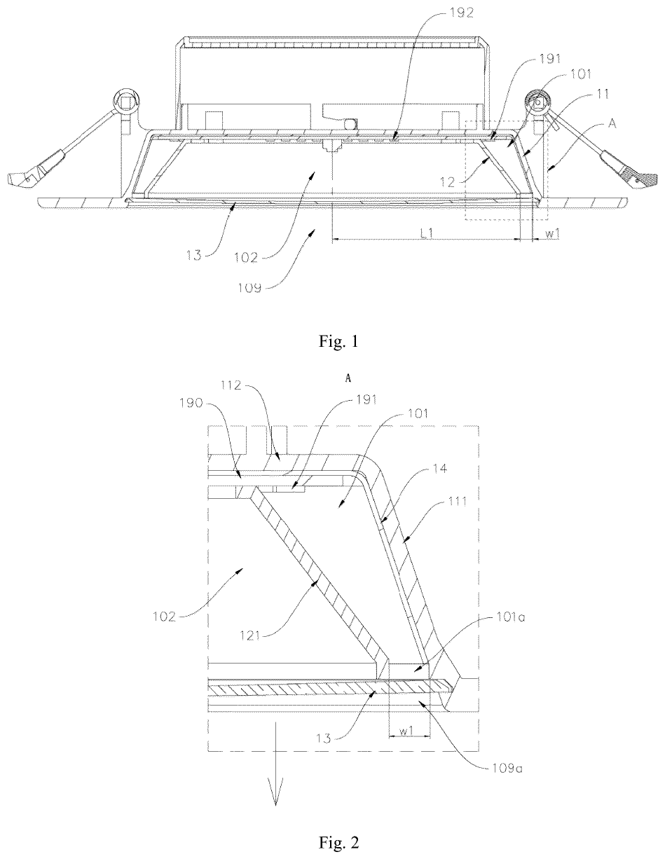

With reference to FIGS. 1-2, a downlight is provided in the embodiment. The downlight includes a lamp body assembly and a light source assembly. Moreover, the downlight further includes a mounting assembly for being mounted to a building structure. The lamp body assembly includes a lamp body 11, a light reflecting cup 12 and a lampshade 13. The light source assembly includes a circuit board 190, a first light source 191 and a second light source 192. The first light source 191 and the second light source 192 are fixedly connected to the circuit board 190. The first light source 191 and the second light source 192 are coplanar.

The lamp body 11 includes a top wall 112 and an outer peripheral wall 111. The outer peripheral wall 111 serves as an outer peripheral structure in the embodiment. The top wall 112 is a circular shape. The surrounding outer peripheral wall 111 extends downwards and obliquely outwards from an outer peripheral edge of the top wall 112 in a flared shape. Under the top wall 111, an inner mounting space of the lamp body 11 is formed at an inner periphery of the outer peripheral wall 111.

The circuit board 190 is fixed on a lower side of the top wall 112. The first light source 191 and the second light source 192 are LED lamp beads. The first light source 191 serves as a light source for an ambient light and a night light. The second light source 192 serves as a light source for main illumination light. The second light source 192 is distributed at a middle position near a center line of the lamp body 11. The first light source 191 is distributed at an outer edge position away from the center line.

The light reflecting cup 12 includes a trumpet-shaped inner peripheral wall 121. The inner peripheral wall 121 serves as an inner peripheral structure in the embodiment. The light reflecting cup 12 is fixedly mounted in the above inner mounting space and is arranged with the center line of the lamp body 11 as a center. In this way, the inner peripheral wall 121 is located at the inner periphery of the outer peripheral wall 111. An inner periphery of the inner peripheral wall 121 defines a middle space 102. A surrounding outer edge space 101 is formed between an outer periphery of the inner peripheral wall 121 and the inner periphery of the outer peripheral wall 111. The second light source 192 is arranged in the middle space 102 through an opening at a top of the light reflecting cup 12. The first light source 191 is located in the outer edge space 101.

A lower side of the downlight shown in FIG. 1 is a light emergent side 109 of the present disclosure. When the downlight is mounted on a ceiling, the light emergent side 109 faces downwards. The lower side of the middle space 102 is open. A lower side of the outer edge space 101 is similarly provided with an annular outlet 101a. The outlet 101a is formed between a bottom of the inner peripheral wall 121 and the outer peripheral wall 111.

The lampshade 13 is of a semi-light-transmission structure. The disc-shaped lampshade 13 is fixedly mounted at a bottom of the outer peripheral wall 111. The lampshade 13 blocks an opening of the middle space 102 and also blocks the outlet 101a of the outer edge space 101.

The light emergent side 109 is provided with an outer edge light emergent area 109a opposite to the outlet 101a of the outer edge space 101. The outer edge light emergent area 109a mainly refers to an annular area of the night light or the ambient light after the first light source 191 emits light. The present disclosure limits a width of the outer edge light emergent area, so as to present a narrow-ring or narrow-slit light emergent effect, and then the night light or the ambient light produces a softer and more comfortable illumination effect.

However, a boundary of light is difficult to determine and calculate. Thus it is necessary to take a specific structure size with largest correlation on the lamp as the width of the outer edge light emergent area. In the embodiment, light rays of the first light source 191 is able to reach to the lampshade 13 through the outlet 101a. It can be seen that a width w1 of the annular outlet 101a determines the width of the outer edge light emergent area.

In the embodiment, in the present disclosure, a ratio of the width w1 of the outlet 101a to a distance L1 from the outlet 101a of the outer edge space 101 to a center of the light emergent side 109 is controlled between 1:100 and 3:10. The width w1 is a first size, that is, a distance between the outer peripheral structure and the inner peripheral structure in the present disclosure. The distance L1 from an inner edge of the outlet 101a of the outer edge space 101 to a center line of the light emergent side 109 is a distance from the outer edge space 101 to the center of the light emergent side 109. Both the width w1 and the distance L1 are radial sizes of the lamp body 11 and also are sizes on an orthographic projection of the light emergent side in the present disclosure. The orthographic projection on the light emergent side is a projection in a direction from bottom to top as shown in FIG. 1.

### Lamp Embodiment 2

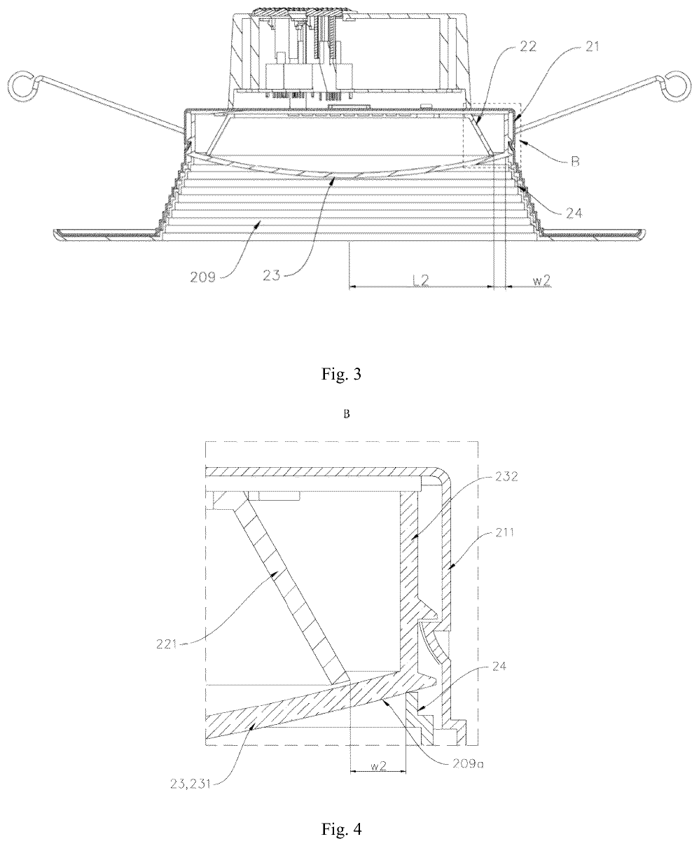

With reference to FIGS. 3-4, in the embodiment, a lamp body assembly includes a lamp body 21, a light reflecting cup 22 and a lampshade 23, and also includes an anti-glare ring 24.

In the embodiment, the lampshade 23 includes a cover surface 231, and further includes a mounting peripheral wall 232 extending upwards from an outer peripheral edge of the cover surface 231. The lampshade 23 is fixed by being connected to an inner side of the outer peripheral wall 211 through the mounting peripheral wall 232.

The anti-glare ring 24 is fixed to a position on a light emergent side 209 lower than the lampshade 23. In the embodiment, the outer peripheral wall 211 is much longer than an inner peripheral wall 221 of the light reflecting cup 22 and extends downwards to a lower position. The anti-glare ring 24 is fixed to an inner side of a lower portion of the outer peripheral wall 211.

With reference to FIG. 4, the anti-glare ring 24 is a light shielding member. The light shielding member 24 is closer to the inner periphery than the outer peripheral wall 211 and abuts against a lower surface of the cover surface 231. It can be seen from the embodiment that when a first light source emits light from an outer edge space, an emission range of the first light source is limited by the anti-glare ring 24. Thus based on a structure of the lamp body assembly of the embodiment, a width w2 of an outer edge light emergent area 209a is a distance in a radial direction of the lamp body 11 between a lower end of the inner peripheral wall 221 of the light reflecting cup 22 and an upper end of the anti-glare ring 24 on an orthographic projection on the light emergent side. A distance L2 from the outer edge light emergent area 209a to a center of the light emergent side 209 is the same as that in embodiment 1.

It can be seen in combination with lamp embodiment 1 and lamp embodiment 2, the width of the outer edge light emergent area is determined by the distance between the inner peripheral structure and the outer peripheral structure within the lamp body assembly, and should be based on a width of the outlet set on the light emergent side of the outer edge space. The width of the outlet is a distance between structures constituting the outlet and located on an inner side and an outer side of the outlet. In other embodiments, when the lamp body assembly includes the anti-glare ring, the outlet is still practically defined by the inner peripheral wall of the light reflecting cup and the outer peripheral wall of the lamp body. In this case, the width of the outer edge light emergent area is determined by a distance between the inner peripheral wall and the outer peripheral wall.

### Lamp Embodiment 3

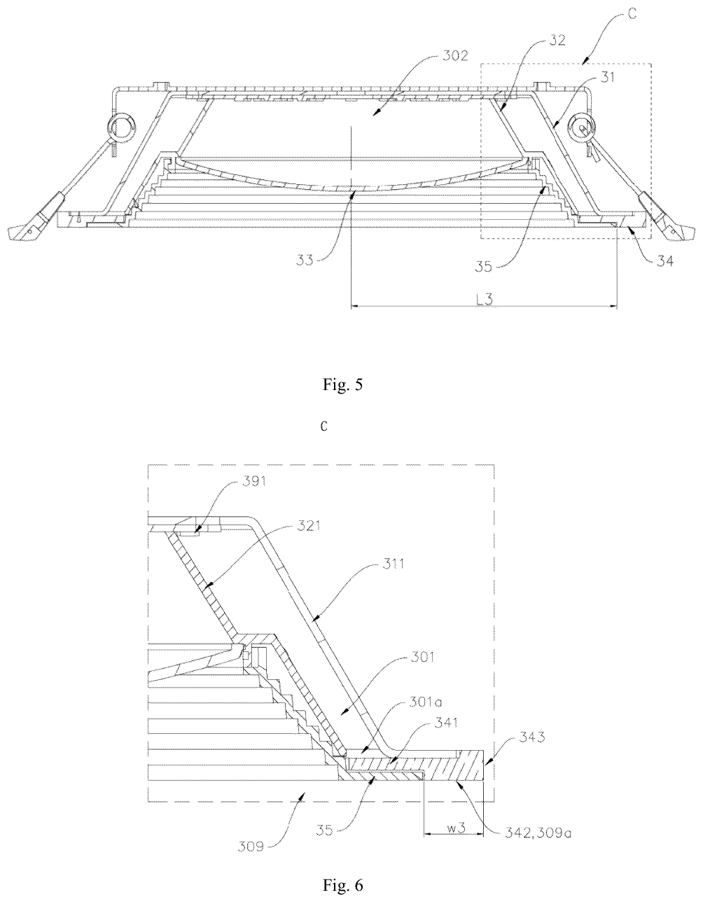

With reference to FIGS. 5-7, a lamp body assembly in the embodiment includes a lamp body 31, a light reflecting cup 32, a lampshade 33 and an anti-glare ring 35, and further includes a light transmission ring 34. The light transmission ring 34 is a light transmission member of the present disclosure. The anti-glare ring 35 is a light shielding member of the present disclosure. The light reflecting cup 32 is an inner peripheral structure of the embodiment. In this way, an outer edge space 301 is formed between the light reflecting cup 32 and the outer peripheral wall 311. An outlet 301a of the outer edge space 301 is located between a bottom edge of the light reflecting cup 32 and a bottom of the outer peripheral wall 311. The light transmission ring 34 is arranged at the outlet 301a. The light transmission member 34 only transmits light from the outlet 301a.

In the embodiment, the anti-glare ring 35 is fixed on an inner side of an inner peripheral wall 321 of the light reflecting cup 32. The lampshade 33 only blocks an outlet of a middle space 302, but does not block the outlet of the outer edge space 301.

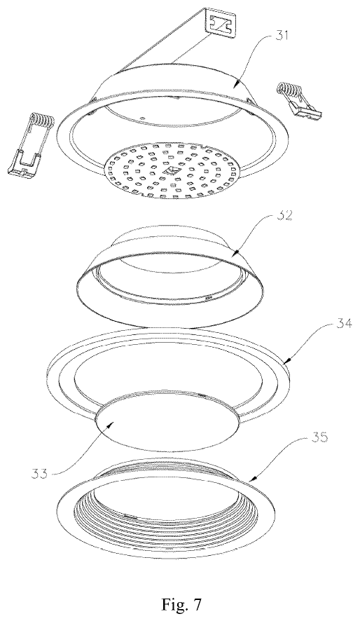

In the embodiment, a bottom of the anti-glare ring 35 blocks the outer edge space 301 from a forward direction of the light emergent side 309, that is, blocks the outlet 301a of the outer edge space 301 from a position below the outer edge space 301 as shown in FIG. 6.

A first portion 341 of the light transmission ring 34 is located between the bottom of the anti-glare ring 35 and the outer peripheral wall 311 and directly below the outlet 301a. The light transmission ring 34 extends outwards from the first portion 341 to an outer periphery of the anti-glare ring 35. A downward front light emergent surface 342 of the light transmission ring 34 is exposed to a light emergent side 309 from an outer periphery of the anti-glare ring 35. Thus light rays from a first light source 391 enter the first portion 341 of the light transmission ring 34 and exit from the front light emergent surface 342.

It can be seen that in the structure, the first light source 391 cannot directly reach the light emergent side 309 through the outlet 301a, but needs to emit light after being guided by the light transmission ring 34. Accordingly, in the embodiment, a width of an outer edge light emergent area 309a is practically not related to a width of the outlet 301a, but is related to a width of the downward front light emergent surface 342 of the light transmission ring 34. Thus the width w3 of the outer edge light emergent area 309a in the embodiment is a second size of the present disclosure, that is, a width of the exposed front light emergent surface 342 of the light transmission ring 34 in a radial direction of the lamp body 31 on an orthographic projection on the light emergent side 309. A distance L3 from the outer edge light emergent area 309a to a center of the light emergent side 309 is a distance L3 from an inner peripheral edge of the front light emergent surface 342 to a center line of the lamp body 31 in the radial direction of the lamp body 31 on the orthographic projection on the light emergent side 309.

Moreover, in the embodiment, the light transmission ring 34 includes a side light emergent surface 343. The side light emergent surface 343 is located on an outer periphery of a lamp.

### Lamp Embodiment 4

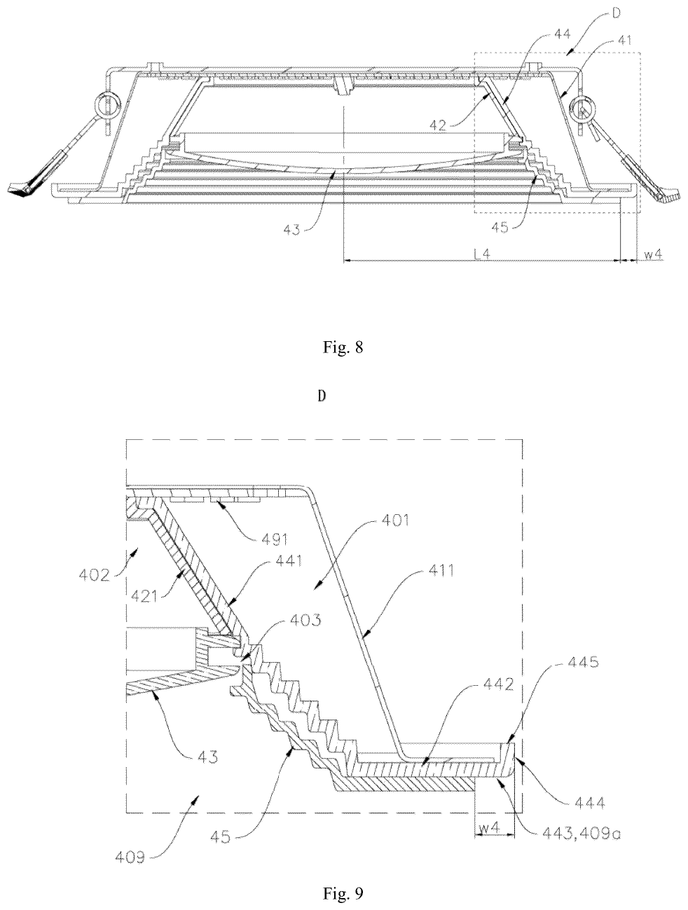

With reference to FIGS. 8-9, a lamp body assembly in the embodiment includes a lamp body 41, a light reflecting cup 42, a lampshade 43, a light transmission lamp cup 44 and an anti-glare ring 45. The light transmission lamp cup 44 is a light transmission member of the embodiment. The anti-glare ring 45 is a light shielding member of the embodiment.

The light transmission lamp cup 44 includes a cup portion 441 and a ring portion 442. The cup portion 441 sleeves an outer side of an inner peripheral wall 421 of the light reflecting cup 42 and is located on an inner side of an outer edge space 401. A lower portion of the cup portion 441 extends downwards to a lower side of the inner peripheral wall 421. The lampshade 43 only shields a middle space 402. The lampshade 43 is buckled to an inner side of the cup portion 441. The anti-glare ring 45 is arranged on an inner side of the lower portion of the cup portion 441. An upper portion of the anti-glare ring 45 is buckled to an outer periphery of the lampshade 43.

In the light transmission lamp cup 44, the cup portion 441 extends between an outer side of the inner peripheral wall 421 and an outer side of the anti-glare ring 45. A bottom of the anti-glare ring 45 similarly shields the outer edge space 401 from directly below the outer edge space 401, that is, from a forward direction of a light emergent side 409. The ring portion 442 is located between an outer peripheral wall 411 and the anti-glare ring 45 and extends from directly above the bottom of the anti-glare ring 45 to an outer periphery of the anti-glare ring 45. A part of a downward front light emergent surface 443 of the ring portion 442 is exposed to the light emergent side 409 from the outer an periphery of the bottom of the anti-glare ring 45. A side light emergent surface 444 of an outer periphery of the ring portion 442 is exposed to an outer periphery of a lamp. Moreover, an outermost edge of the ring portion 442 further includes a back light emergent surface 445 having an orientation opposite to that of the front light emergent surface 443. The side light emergent surface 444 achieves side light emergence of the lamp. The back light emergent surface 445 achieves upward light emergence of the lamp.

It can be seen that in the embodiment, a width of an outer edge light emergent area 409a is a second size of the present disclosure, that is, a width of the exposed front light emergent surface 443 of the light transmission ring 44 in a radial direction of the lamp body 41 on an orthographic projection on the light emergent side 409. It should be noted that the front light emergent surface 443 is not completely exposed in the embodiment. The second size and a distance L4 from the outer edge light emergent area 409a to a center of the light emergent side 409 are calculated according to an exposed part of the front light emergent surface.

Moreover, it can be seen that both embodiment 3 and embodiment 4 may achieve side light emergence of the lamp. With reference to FIG. 9 again, in the embodiment, a light transmission gap 403 is formed between the inner peripheral wall 421 and the anti-glare ring 45. The cup portion 441 is opposite the lampshade 43 through the light transmission gap 403. The lampshade 43 is buckled to the inner side of the cup portion 441 through the light transmission gap 403. Since both the light transmission lamp cup 44 and the lampshade 43 transmit light, light rays of a first light source 491 may be transmitted through the light transmission lamp cup 44, the light transmission gap 403 and the lampshade 43 in sequence, and then emitted from an edge of the lampshade 43.

Thus, a decorative light or a night light may emit light at different positions in different directions.

### Lamp Embodiment 5

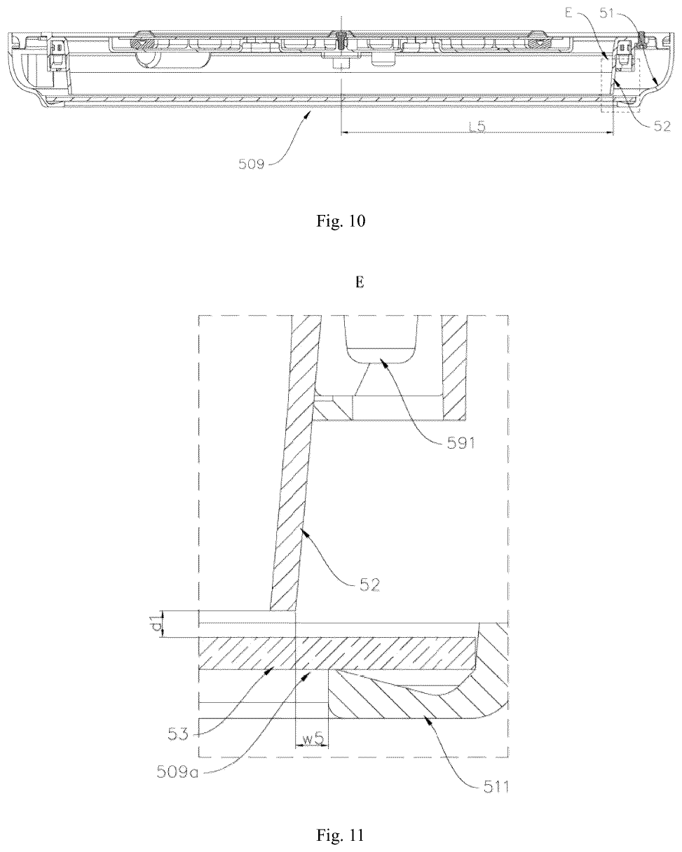

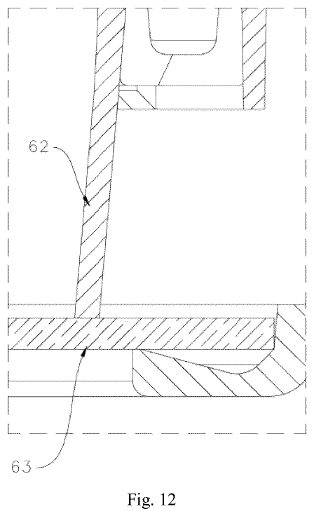

With reference to FIGS. 10-11, the embodiment is a ceiling lamp. In a lamp body assembly, an outer peripheral structure of is a housing 51 surrounding an outer periphery of the ceiling lamp, and an inner peripheral structure is an annular component 52. The housing 51 gradually converges along an arc from top to bottom. A bottom 511 of the housing 51 extends radially towards a center of the lamp body assembly. A lampshade 53 is supported on an annular bottom 511. The annular component 52 is located above the lampshade 53. A gap d1 is provided between the annular component 52 and the lampshade 53 in a forward direction of the light emergent side 509, that is, in an up-down direction.

In the embodiment, a width w5 of an outer edge light emergent area 509a is a first size of the present disclosure, that is, a distance between an outer peripheral edge of a lower end of the annular component 52 and an inner peripheral edge of the bottom 511 of the housing 51 in a radial direction of the lamp body assembly on an orthographic projection on the light emergent side 509. On the orthographic projection on the light emergent side 509, a distance L5 from the outer edge light emergent area 509a to a center of the light emergent side 509 is a distance between the outer peripheral edge of the lower end of the annular component 52 and a center line of the light emergent side 509.

In practice, the arrangement of the gap d1 allows light of the first light source 591 to penetrate from the gap d1 and to be closer to a middle light emergent area. In this way, when the outer edge light emergent area 509a and the middle light emergent area emit light simultaneously, main light and decorative light overlap with each other at a boundary between the main light and the decorative light, a rigid light boundary is weakened, and a softer and more comfortable halo effect is produced. The greater the gap d1 is, the greater a degree of overlap between the two types of light is. In the embodiment, the gap d1 is 2 mm. In other embodiments, the gap may be less than 2 mm.

### Lamp Embodiment 6

With reference to FIG. 12 and compared with FIG. 11, different from embodiment 5, the embodiment is provided with no gap d1 of embodiment 5, that is, a bottom of an annular component 62 makes contact with a lampshade 63. In this way, a clear boundary is formed between two kinds of light.

In the above embodiments, on the orthographic projection on the light emergent side, the outer edge light emergent area is annular. In the above embodiments, on the orthographic projection on the light emergent side, the ratio of the width of the outer edge light emergent area to the distance from the outer edge light emergent area to the center of the light emergent side ranges from 1:100 to 3:10. The ratio in the present disclosure ranges from 1:100 to 3:10, and includes two endpoint values of 1:100 and 3:10. Thus the width of the outer edge light emergent area is limited, and finally a narrow-ring or narrow-slit light emergent effect is presented, such that a softer and more comfortable illumination effect is produced, and use experience is improved. In some embodiments, the ratio of the width of the outer edge light emergent area to the distance from the outer edge light emergent area to the center of the light emergent side is 1:100, 2:100, 7:100, 1:10, or 1:5.

In the present disclosure, the light emergent side refers to a side with a maximum light emergent surface on a lamp. The light emergent side includes all parts arranged on the side facing the maximum light emergent surface. All the parts include a plurality of parts located on a same plane or not.

In the embodiment, in a case of a non-circular lamp, a center of a light emergent side is determined according to a geometric center of an inner peripheral structure.

In other embodiments, the outer edge space is not a surrounding space. In an embodiment, the outer edge space is circumferentially partitioned to form a plurality of mutually independent arc-shaped spaces. Accordingly, the outer edge light emergent area and a final light effect are of a discontinuous ring shape.

In other embodiments, the inner peripheral structure may also be a lamp cup, a light shielding cover, etc., which are provided in existing lamps. Any component, member or assembly located between the outer edge space and the middle space may be used as the inner peripheral structure of the present disclosure.

Finally, it should be emphasized that what are mentioned above are merely preferred embodiments of the present disclosure, and are not intended to limit the present disclosure. For those skilled in the art, various changes and modifications may be made to the present disclosure. Any modification, equivalent substitution, improvement, etc. made within the spirit and principle of the present disclosure should be included in the scope of protection of the present disclosure.

What is claimed is:

1. A lamp body assembly, comprising an outer peripheral structure, an inner peripheral structure and a light transmission member, wherein the inner peripheral structure is arranged on an inner periphery of the outer peripheral structure, an outer edge space is formed between the inner peripheral structure and the outer peripheral structure, a middle space is formed by an inner periphery of the inner peripheral structure, a light emergent side of the lamp body assembly comprises an outer edge light emergent area corresponding to the outer edge space, and the light transmission member is arranged between the outer edge space and the outer edge light emergent area;
wherein,
on an orthographic projection of the light emergent side, a ratio of a width of the outer edge light emergent area to a distance from the outer edge light emergent area to a center of the light emergent side ranges from 1:100 to 3:10;
the width of the outer edge light emergent area is a first size or a second size;
the first size is a distance between the outer peripheral structure and the inner peripheral structure at an outlet of the outer edge space on the orthographic projection of the light emergent side; and
the second size is a width of an exposed front light emergent surface of the light transmission member on the orthographic projection of the light emergent side.

2. The lamp body assembly according to claim 1, wherein,
the light transmission member comprises a lampshade, and the lampshade is arranged at an outlet of the middle space and the outlet of the outer edge space; and
the width of the outer edge light emergent area is the first size.

3. The lamp body assembly according to claim 2, wherein,
the lamp body assembly comprises a lamp body, wherein the lamp body comprises an outer peripheral wall;
the lamp body assembly further comprises an anti-glare ring, and the anti-glare ring is connected to an inner side of the outer peripheral wall;
the outer peripheral structure comprises the outer peripheral wall and the anti-glare ring, and the outer edge space is located between the inner peripheral structure and the outer peripheral wall; and
the first size is a distance between the outer peripheral wall and the inner peripheral structure or a distance between the anti-glare ring and the inner peripheral structure at the outlet of the outer edge space on the orthographic projection of the light emergent side.

4. The lamp body assembly according to claim 2, wherein,
a gap is formed between the inner peripheral structure and the lampshade in a forward direction on the light emergent side.

5. The lamp body assembly according to claim 1, wherein,
the lamp body assembly comprises a light shielding member arranged on the light emergent side, wherein,
the light shielding member shields the outer edge space from a forward direction of the light emergent side;
the light transmission member extends from a position between the light shielding member and the outer peripheral structure to an outer periphery of the light shielding member, and at least a part of the front light emergent surface is exposed to the light emergent side from the outer periphery of the light shielding member; and
the width of the outer edge light emergent area is the second size.

6. The lamp body assembly according to claim 5, wherein,
the light transmission member comprises a cup portion and a ring portion, the cup portion sleeves the inner peripheral structure, and the ring portion is arranged on the light emergent side; and
a light transmission gap is formed between the inner peripheral structure and the light shielding member, and the cup portion is arranged towards the light transmission gap.

7. The lamp body assembly according to claim 6, wherein,
the lamp body assembly comprises a lampshade, the lampshade is arranged on the light emergent side and shields the middle space; and
the cup portion is opposite the lampshade through the light transmission gap.

8. The lamp body assembly according to claim 7, wherein,
the lampshade is connected to the light transmission member, and the light shielding member is connected to the lampshade.

9. The lamp body assembly according to claim 7, wherein,
in an orientation of the light emergent side, a light emergent surface of the lampshade and the front light emergent surface are located at different positions.

10. The lamp body assembly according to claim 9, wherein,
in the orientation of the light emergent side, the front light emergent surface is farther away from a first light source and/or a second light source than the light emergent surface of the lampshade.

11. The lamp body assembly according to claim 5, wherein,
the inner peripheral structure comprises a light reflecting cup, and the outlet of the outer edge space is formed between an edge of the light reflecting cup and the outer peripheral structure; and
the light transmission member comprises a light transmission ring, and the light transmission ring is arranged at the outlet of the outer edge space.

12. The lamp body assembly according to claim 5, wherein,
the light transmission member further comprises a side light emergent surface, and the side light emergent surface is located on an outer periphery of the lamp body assembly;
and/or,
a part of the light transmission member is located at an outer peripheral edge of the lamp body assembly, and the part of the light transmission member comprises a back light emergent surface having an orientation opposite to that of the front light emergent surface;
and/or,
the light shielding member comprises an anti-glare ring.

13. The lamp body assembly according to claim 1, wherein,
on the orthographic projection of the light emergent side, the outer edge light emergent area is an annular, an arc-shaped or a discontinuous annular.

14. The lamp body assembly according to claim 1, wherein,
the lamp body assembly comprises a lamp body and a circuit board, wherein the lamp body comprises a top wall and an outer peripheral wall, and the outer peripheral wall comprises the outer peripheral structure; and
the circuit board is fixed on a lower side of the top wall, a first light source and a second light source are fixedly connected to the circuit board, and the first light source and the second light source are coplanar.

15. The lamp body assembly according to claim 1, wherein,
the inner peripheral structure is a light reflecting cup, a lamp cup, a light shielding cover or an annular component.

16. A lamp, comprising a lamp body assembly, a first light source and a second light source, wherein,
the lamp body assembly according to claim 1 is used as the lamp body assembly, the first light source is arranged in the outer edge space of the lamp body assembly, and the second light source is arranged in the middle space of the lamp body assembly.

17. The lamp body assembly according to claim 1, wherein,
the lamp body assembly comprises a lampshade, the outer peripheral structure is a housing surrounding within the lamp body assembly, the housing gradually converges along an arc from top to bottom, and a bottom of the housing extends radially towards a center of the lamp body assembly, the lampshade is supported on an annular bottom; and
the inner peripheral structure is an annular component, the annular component is located above the lampshade, a gap d1 is provided between the annular component and the lampshade in a forward direction of the light emergent side;
preferably, the gap d1 is less than or equal to 2 mm.

18. The lamp body assembly according to claim 1, wherein,
the outlet is formed between a bottom of the inner peripheral wall and the outer peripheral wall.

19. The lamp body assembly according to claim 3, wherein,
the lampshade is of a semi-light-transmission structure;
and/or,
the lampshade is fixedly mounted at a bottom of the outer peripheral wall, and the lampshade blocks an opening of the middle space and also blocks the outlet of the outer edge space.

20. The lamp body assembly according to claim 6, wherein,
a first light source in the outer edge space emits light from an inner peripheral position of the light shielding member through the light transmission gap, a light emitted from the first light source exits through at least two different light paths.
